(19) United States
(12) Patent Application Publication
(10) Pub. No.: US 2021/0089900 A1
(43) Pub. Date: Mar. 25, 2021

(54) TRANSFORMER DGA DATA PREDICTION METHOD BASED ON MULTI-DIMENSIONAL TIME SEQUENCE FRAME CONVOLUTION LSTM

(71) Applicant: WUHAN UNIVERSITY, Hubei (CN)

(72) Inventors: Yigang HE, HUBEI (CN); Jiajun DUAN, HUBEI (CN); Liulu HE, HUBEI (CN); Wenjie WU, HUBEI (CN)

(73) Assignee: WUHAN UNIVERSITY, Hubei (CN)

(21) Appl. No.: 17/020,836

(22) Filed: Sep. 15, 2020

(30) Foreign Application Priority Data
Sep. 20, 2019 (CN) 201910891134.X

(51) Int. Cl. G06N 3/08; G06N 3/04

(52) U.S. Cl. CPC G06N 3/08; G16Y 10/35; G06N 3/04

(57) ABSTRACT

The disclosure discloses a transformer DGA data prediction method based on multi-dimensional time sequence frame convolution LSTM, including the steps: firstly, collecting and dividing monitoring information of dissolved gas in transformer substation oil into a test set and a verification set; secondly, extracting characteristic parameters by adopting a non-coding ratio method, deleting data which are basically kept unchanged, and performing normalization, noise superposition etc.; performing windowing transformation on the processed data set to form a time sequence frame; constructing a C-LSTM network, and inputting the time sequence frame data into a network convolution layer to obtain a time sequence characteristic quantity; training the C-LSTM network through the training set and the verification set, performing a prediction effect test by using the verification set, and continuously optimizing network parameters; and setting a network updating cycle, and continuously updating the to-be-predicted transformer in a later monitoring task.

### CROSS-REFERENCE TO RELATED APPLICATION

This application claims the priority benefit of China application serial no. 201910891134.X, filed on Sep. 20, 2019. The entirety of the above-mentioned patent application is hereby incorporated by reference herein and made a part of this specification.

### BACKGROUND

### Field of the Disclosure

The disclosure relates to a power transformer fault prediction method, in particular to a data prediction method of dissolved gas in transformer oil, for which a model is trained and established based on time sequence frame convolution extraction characteristics and LSTM deep learning frame.

### Description of Related Art

Power transformers play a vital role in the power system, and serve as the basis for economic, safe and stable operation of the power system. With the gradual improvement of Industry 4.0 and the popularity of Internet of Things, there is an explosive growth of online monitoring data of power transformers. Dissolved gas analysis (DGA) can comprehensively reflect transformer operation and maintenance information, and comprehensively utilize advanced technologies such as artificial intelligence and big data to analyze the trend of DGA monitoring data of power transformers, and therefore DGA is a major issue for research pertaining to transformer health management.

Traditional prediction research on transformer DGA data mainly uses statistical models or artificial intelligence (AI) models to summarize the distribution pattern of the data. For example, the statistical models include Grey Model (GM), Time-Series Analysis model, etc. The prediction accuracy of the above models is limited by the uncertain distribution of the data itself. With further development of AI technology, AI-related models have also begun to be applied in the field of DGA data prediction. Dai Jiejie and others utilized the correlation between massive monitoring data and took comprehensive consideration of the influence of various dynamic factors on the change pattern of DGA data. To avoid the problem of poor effect of DGA data prediction due to the consideration of only a single factor, Lin J et al. proposed a power transformer operating state prediction method based on LSTM DBN, which combines the characteristics of DBN and LSTM to achieve accurate prediction of transformer DGA content. However, the existing DGA prediction technology typically utilizes statistical pattern to perform trend regression and analysis, which makes it difficult to extract the complex correlation between data sequences, and there are disadvantages such as poor anti-noise ability and low prediction accuracy. CNN was originally applied in the field of image and video processing, through CNN's powerful characteristic extraction capabilities and LSTM's in-depth learning of time sequence, the prediction effect of CNN can be improved.

### SUMMARY OF THE DISCLOSURE

The purpose of the disclosure is to provide a smart prediction method for analyzing data of dissolved gas in transformer oil, improve the accuracy of prediction, and solve the problem of conventional methods, which is the difficulties in processing data association relationships and massive data.

The disclosure is realized by adopting the following technical solutions:

A transformer DGA data prediction method based on multi-dimensional time sequence frame convolution LSTM is provided, which is characterized in including the following steps:

1) Monitoring information of dissolved gas in transformer substation oil is collected and sorted according to time sequence, the monitoring information includes the content of key gas in DGA state of the transformer, and the monitoring information is divided into a test set and a verification set randomly according to a specific proportion.

2) Characteristic parameters are extracted from the test set and the verification set by adopting a non-coding ratio method, the characteristic parameters are the ratios between different gases or between different combinations of gases, and the data of the characteristic parameters is preprocessed.

3) Windowing transformation is performed on a data set of the preprocessed characteristic parameters to form a time sequence frame.

4) A C-LSTM network is constructed, which includes an input layer, a convolution layer, an LSTM layer, and an output layer; the input layer reads the time sequence frame and inputs the time sequence frame to the convolution layer to obtain a time sequence characteristic quantity.

5) The data of the test set is input into the LSTM layer of the C-LSTM network for training and is verified by using the verification set; the network parameters are continuously updated to obtain a trained C-LSTM network prediction model.

6) The DGA data of the transformer to be monitored is input into the trained C-LSTM network prediction model for prediction, and the new DGA data of the transformer to be monitored is added to the test set and the verification set simultaneously to perform repeated calculation and update on the network parameters of the C-LSTM network prediction model again.

Following the above technical solution, the monitoring information of dissolved gases in the transformer substation oil in step 1) is retrieved from relevant literature. Each group of data of the monitoring information is sorted according to time sequence and at least includes the content of key gas in DGA state of the transformer: hydrogen Hz, methane CH₄, ethane C₂H₆, ethylene C₂H₄, and acetylene C₂H₂.

Following the above-mentioned technical solution, the training set and the verification set are divided through proportional random sampling.

Following the above technical solution, in step 2), the following nine ratios of gas are extracted as the characteristic parameters by using the non-coding ratio method: CH₄/H₂, C₂H₄/(C₁+C₂), C₂H₄/C₂H₂, C₂H₂/(C₁+C₂), CH₄/(C₁+C₂), H₂/(H₂+C₁+C₂), C₂H₄/C₂H₆, (CH₄+C₂H₄)/(C₁+C₂) and C₂H₆/(C₁+C₂), wherein C₁ is a hydrocarbon with one carbon (CH₄) and C₂ is a hydrocarbon with two carbons (C₂H₆, C₂H₄, C₂H₂); a maximum value of the ratios is set, if the denominator is zero, then a calculation result of the ratios is set as the maximum value.

Following the above technical solution, the preprocessing operation is specifically as follows: a global normalization process is performed on the data; a shorter sequence or a sequence with a non-linear sampling time is expanded by interpolation and superimposed with Gaussian noise.

Following the above technical solution, the method of performing windowing transformation to form a time sequence frame in step 3) is: the result obtained by the non-coding ratio method is formed into a matrix of k rows and n columns, and each ratio is arranged as a row according to the sampling time distribution, and k is the number of characteristic parameters. The matrix filter with x rows and a length being the window size m is used to slide along the sampling time and the characteristic parameters in sequence. The sliding stride is s, and one frame is obtained when each step is moved by one time stride, and a total of (k−x+1)(n−m+1) frames are obtained and arranged along the time axis to form a matrix of x×m×(k−x+1)(n−m+1), that is, the time sequence frame.

Following the above technical solution, after the time sequence frame in step 4) is subjected to the activation function of the last pooling layer of the convolution layer in the C-LSTM network prediction model, the original matrix of x×m×(k−x+1)(n−m+1) is changed into a characteristic vector sequence of D×(k−x+1)(n−m+1), wherein D is the number of characteristic parameters.

Following the above technical solution, the training method of the C-LSTM network prediction model in step 5) is as follows: first, the number of training cycles, the minimum training batch, the activation function, and the learning rate are set; the time sequence frame obtained by the training set after step 2) to step 3) serves as the network input; then the calculation method of network error is set. If the learning ability expressed by high-level time needs to be enhanced, multiple LSTM layers are set. Finally the network training is performed to obtain the C-LSTM prediction network model. In the training process, each time the next time sequence value is obtained, it is considered that the true value at the previous moment is known, and the network parameters are continuously updated through the effect of the verification set test, and finally a trained C-LSTM network prediction model is obtained.

Following the above technical solution, the method of repeated calculation and update of the C-LSTM network prediction model at a later stage in step 6) is as follows: first, the update frequency of the C-LSTM network prediction model is set at a frequency of updating by every q times of monitoring sampling. When q new monitoring data is obtained, the previous monitoring information of the transformer to be predicted is added to the training set and the verification set simultaneously, and return to step 2) to repeatedly calculate and update the network parameters.

The disclosure also provides a transformer DGA data prediction system based on multi-dimensional time sequence frame convolution LSTM, which includes:

an information collecting module, configured to collect and sort monitoring information of dissolved gas in transformer substation oil according to time sequence, the monitoring information includes the content of key gas in DGA state of the transformer, and the monitoring information is divided into a test set and a verification set randomly according to a specific proportion;

a characteristic parameter extracting module, configured to extract characteristic parameters from the test set and the verification set by adopting a non-coding ratio method, the characteristic parameters are the ratios between different gases or between different combinations of gases, and the data of the characteristic parameters is preprocessed;

a data transforming module, configured to perform windowing transformation on a data set of the preprocessed characteristic parameters to form a time sequence frame;

a C-LSTM network constructing module, configured to construct the C-LSTM network, which includes an input layer, a convolution layer, an LSTM layer, and an output layer; the input layer reads the time sequence frame and inputs the time sequence frame to the convolution layer to obtain a time sequence characteristic quantity;

a C-LSTM network training module, configured to input the data of the test set into the LSTM layer of the C-LSTM network for training and use the verification set for verification; the network parameters are continuously updated to obtain a trained C-LSTM network prediction model;

a testing module, configured to input the DGA data of the transformer to be monitored into the trained C-LSTM network prediction model for prediction;

an updating module, configured to add the new DGA data of the transformer to be monitored to the test set and the verification set simultaneously to perform repeated calculation and update on the network parameters of the C-LSTM network prediction model again.

### BRIEF DESCRIPTION OF THE DRAWINGS

The disclosure will be further described below in conjunction with the accompanying drawings and embodiments. In the accompanying drawings:

FIG. 1 is a flowchart of a transformer DGA data prediction method based on multi-dimensional time sequence frame convolution LSTM according to an embodiment of the disclosure.

FIG. 2 is a characteristic extraction method based on windowing time sequence frames according to an embodiment of the disclosure.

FIG. 3 is a method of performing windowing to form a time sequence frame according to an embodiment of the disclosure (stride s=1, window size x=characteristic parameter quantity k).

FIG. 4 is a C-LSTM network structure according to an embodiment of the disclosure.

FIG. 5 is a network training process according to an embodiment of the disclosure.

FIG. 6 is a comparison curve of the C-LSTM prediction result and the prediction effect of the LSTM method according to an embodiment of the disclosure.

FIG. 7 is a comparison image of error variation and root mean square error (RMSE) according to an embodiment of the disclosure.

FIG. 8 is a transformer DGA data prediction system based on multi-dimensional time sequence frame convolution LSTM according to an embodiment of the disclosure.

### DESCRIPTION OF EMBODIMENTS

The advantageous effects brought by the disclosure are: the disclosure introduces the convolution LSTM network (Long Short-Term Memory) into the transformer fault prediction, so as to fully extract the in-depth characteristics of the DGA data ratio, and take into consideration the complex correlation between multi-dimensional time sequence, thereby achieving more accurate predictions. From the aspect of video data, the disclosure provides a concept of characteristic extraction by using time sequence frames, which can further explore the context and inter-relationships of time sequences.

In order to make the purpose, technical solutions, and advantages of the disclosure clearer, the following further describes the disclosure in detail with reference to the accompanying drawings and embodiments. It should be understood that the specific embodiments described here are only used to explain the disclosure, but not to limit the disclosure.

The disclosure is not only suitable for the prediction method of dissolved gas components in transformer oil, but also can be applied to other prediction fields.

The disclosure comprehensively considers the complex relationship between the dissolved gas components in the transformer oil, the context of the time sequences and different devices, constructs a time sequence frame and performs characteristic extraction through the convolution layer, and finally utilizes the LSTM network to realize fault prediction of dissolved gas components in oil by using the LSTM network.

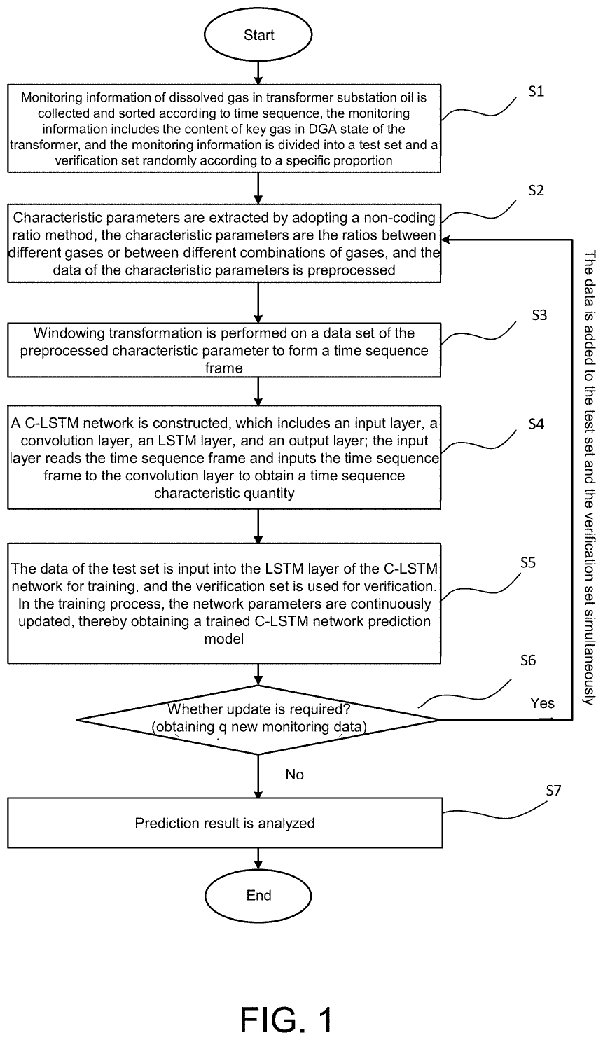

As shown in FIG. 1, the method for predicting transformer DGA data based on multi-dimensional time sequence frame convolution LSTM in an embodiment of the disclosure is characterized in that it includes the following steps:

S1. Monitoring information of dissolved gas in transformer substation oil is collected and sorted according to time sequence, the monitoring information includes the content of key gas in DGA state of the transformer, and the monitoring information is divided into a test set and a verification set randomly according to a specific proportion.

S2. Characteristic parameters are extracted from the test set and the verification set by adopting a non-coding ratio method, the characteristic parameters are the ratios between different gases or between different combinations of gases, and the data of the characteristic parameters is preprocessed.

S3. Windowing transformation is performed on a data set of the preprocessed characteristic parameters to form a time sequence frame.

S4. A C-LSTM network is constructed, which includes an input layer, a convolution layer, an LSTM layer, and an output layer; the input layer reads the time sequence frame and inputs the time sequence frame to the convolution layer to obtain a time sequence characteristic quantity.

S5. The data of the test set is input into the LSTM layer of the C-LSTM network for training, and the data of the verification set is used for verifying the effect of the network training. In the training process, each time the next time sequence value is obtained, it is considered that the true value at the previous moment is known, and the network parameters are continuously updated, thereby obtaining a trained C-LSTM network prediction model.

S6. The DGA monitoring data of the transformer to be predicted is input to the network for prediction. In the prediction process, each time the monitoring value of one moment is obtained, the monitoring value of the previous time stride is a known input. Whether the C-LSTM network prediction model needs to be updated is determined according to the preset update condition (update frequency is once every q times of monitoring sampling). If the C-LSTM network prediction model needs to be updated, the new data is added to the test set and verification set simultaneously, and step S2 is performed again to repeat the above process to repeatedly calculate and update the network parameters of the C-LSTM network prediction model again.

S7. If update is not required, then the prediction result can be analyzed directly.

In a preferred embodiment of the disclosure, the specific implementation steps are as follows:

First, the data of relevant literature over the years is collected. Since most of the literature takes into consideration the monitoring of five characteristic gases, in order to facilitate the collection of data, each group of data of the monitoring information only includes the content of five key gases, including hydrogen (H₂), methane (CH₄), ethane (C₂H₆), ethylene (C₂H₄), and acetylene (C₂H₂), in DGA state of the transformer and operation state thereof, and they are sorted according to time sequence. Since the sampling time and sampling frequency of each group of data are different, the size of the data length n is also varied. It is ensured that the sampling time of the monitoring data is more than 2 weeks, and a total of 100 groups of data is collected, and then 50% of the data is randomly selected as the training set and the other 50% of the data is used as the verification set.

The data is normalized, and uniform interpolation is expanded into time sequences with equal interval, and the interval is four hours. Then, by using the non-coding ratio method, the characteristic parameters are extracted through the ratios between various key gas parameters, and the following gas ratios are obtained through calculation: CH₄/H₂, C₂H₄/(C₁+C₂), C₂H₄/C₂H₂, C₂H₂/(C₁+C₂), CH₄/(C₁+C₂), H₂/(H₂+C₁+C₂), C₂H₄/C₂H₆, (CH₄+C₂H₄)/(C₁+C₂) and C₂H₆/(C₁+C₂), wherein C₁ is a hydrocarbon with one carbon (CH₄) and C₂ is a hydrocarbon with two carbons (C₂H₆, C₂H₄, C₂H₂). Taking into consideration the random errors such as environment noise of the monitoring data and so on, 1% of Gaussian noise is superimposed on the monitoring data.

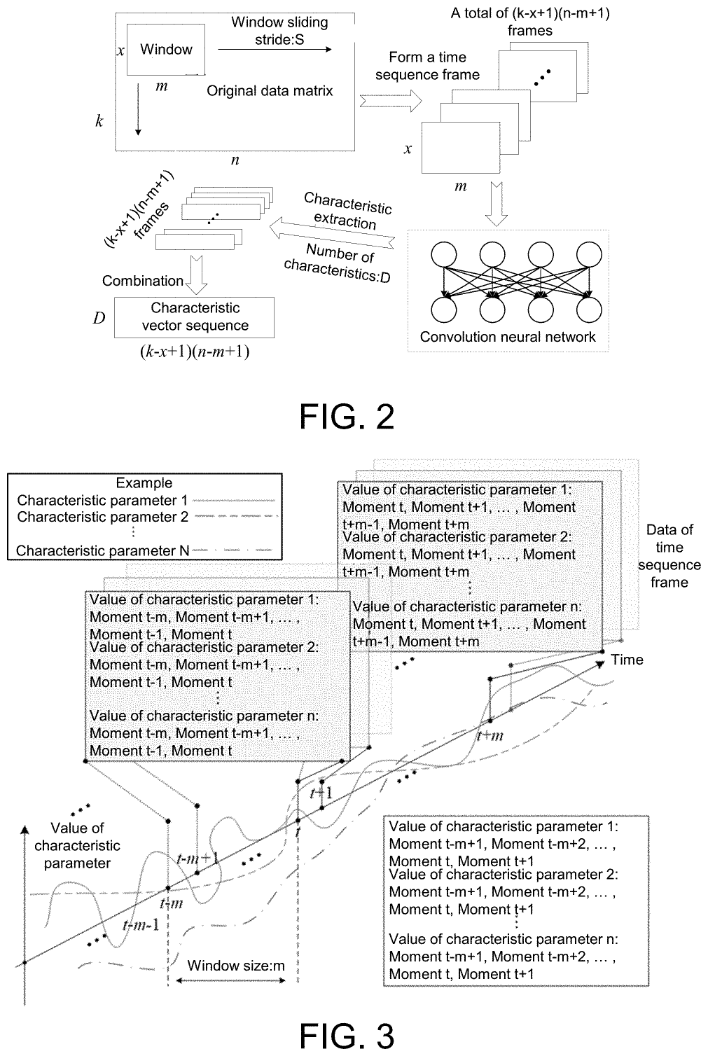

Next, characteristic extraction is performed based on windowed time sequence frames. The data processing flow and data dimension analysis of this characteristic extraction method are shown in FIG. 2. For each group of data obtained (a total of 100 groups of data in the training set and the verification set, each group of data is recorded as the i-th group of data, i=1, 2, . . . , 100). The distribution of each characteristic gas along the sampling time is recorded as one row, and forms a matrix of kᵢ rows and nᵢ columns. In this embodiment, kᵢ is equal to the number of ratios obtained through step S2, that is, kᵢ=9. Then, the matrix filter with x rows and a length being the window size m is used to slide along the sampling time and the characteristic parameters in sequence. The sliding stride is s, and one frame is obtained when each step is moved by one stride. For ease of description, it is set that the number of rows x of the filter matrix=the number of rows kᵢ of the data matrix, that is x=9; stride s=1. When the value is set in the manner described above, the process of performing windowing to form the time sequence frame is described as shown in FIG. 3. The length of the time sequence frame is (nᵢ−m+1), the window size is m=20. Since the sampling cycle is four hours and the sampling time is greater than two weeks, then nᵢ>14×6=84, so it can be ensured that nᵢ−19 will not be less than zero. With the stride sliding over, a 9×20×(nᵢ−19) matrix is obtained, that is, the time sequence frame.

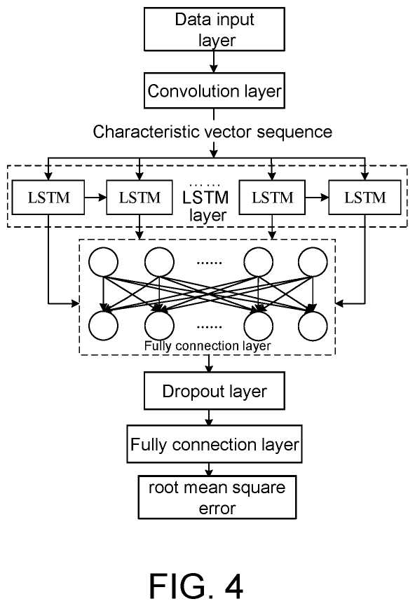

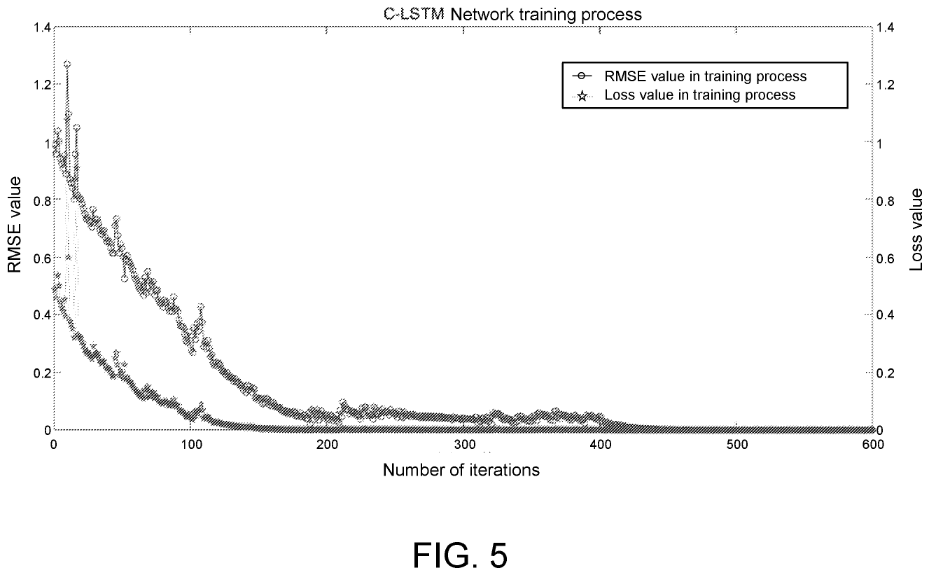

The structure of the constructed C-LSTM network is shown in FIG. 4. The time sequence frame is input into the convolution layer of the network to obtain the time characteristic quantity. In this embodiment, GoogLeNet is selected as the convolution layer. In practice, a lighter or more accurate network can be selected according to specific application scenarios. After being subjected to the activation function of the last pooling layer in the network, the time sequence frame is changed into a D×(nᵢ−19) characteristic vector sequence. Specifically, D is the number of characteristics (that is, the output size of the pooling layer). They correspond to the last nᵢ−19 gas composition values to be predicted. In this embodiment, the content of ethane (C₂H₆) is used as an example for prediction. The characteristic quantity in row D column (nᵢ−19) of all data sets and data of the content of gas to be predicted in row 1 column (nᵢ−19) are used as input to the LSTM network for training and verification. The loss value and RMSE value of the training process are shown in FIG. 5.

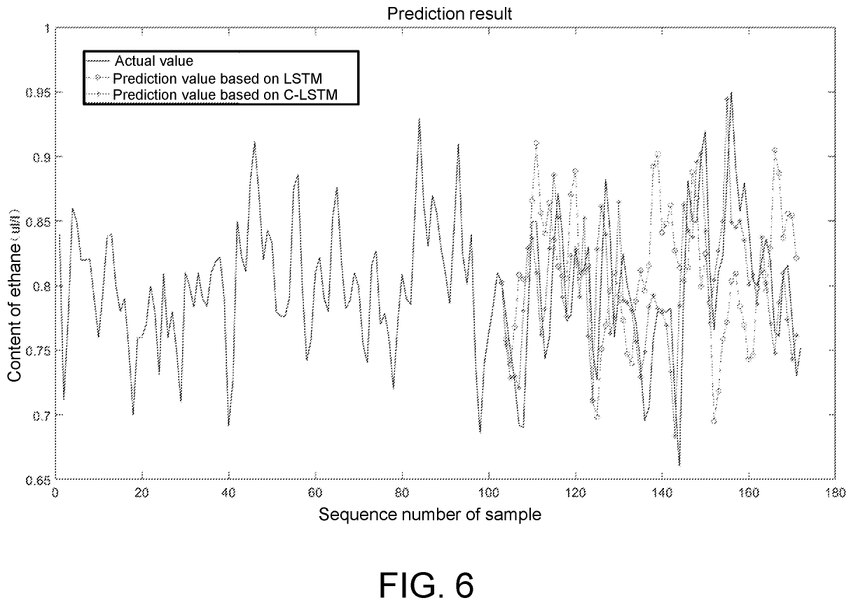

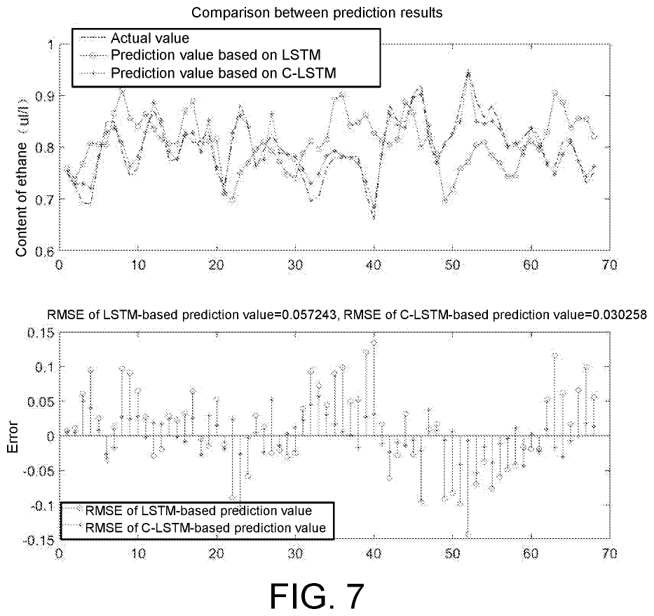

A single LSTM network is utilized to train the methane content curve to obtain the prediction results, and the prediction results of a data set are randomly selected and displayed in FIG. 6 for comparison. FIG. 7 shows the changes in the prediction error and shows a comparison of the root mean square error (RMSE). It can be obtained that after extracting characteristics from time sequence frames, the prediction accuracy rate is better than the prediction results that are obtained by directly using a single parameter without taking into consideration the correlation relationship between time sequence characteristics.

Finally, in the prediction practice of monitoring data for a certain transformer condition, first the network update frequency is set to update every q times of monitoring sampling, and the update frequency should be selected from a larger value. When q new monitoring data is obtained, the previous monitoring information of the transformer to be predicted is added to the training set and the verification set simultaneously, and step S2 is performed again to repeatedly calculate and update the network parameters of the network prediction model.

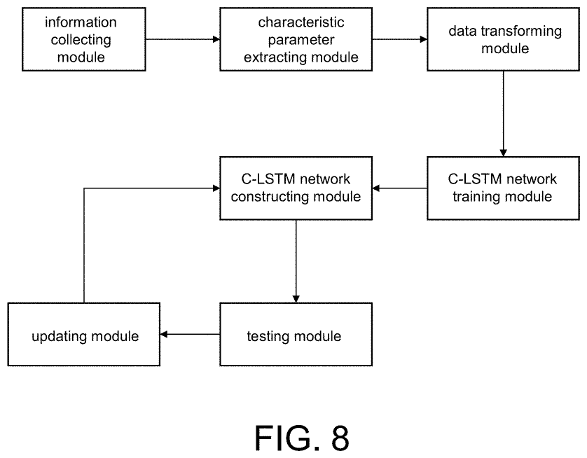

In order to realize the above prediction method, the disclosure also provides a transformer DGA data prediction system based on multi-dimensional time sequence frame convolution LSTM, as shown in FIG. 8, and the system includes:

an information collecting module, configured to collect and sort monitoring information of dissolved gas in transformer substation oil according to time sequence, the monitoring information includes the content of key gas in DGA state of the transformer, and the monitoring information is divided into a test set and a verification set randomly according to a specific proportion;

a characteristic parameter extracting module, configured to extract characteristic parameters from the test set and the verification set by adopting a non-coding ratio method, the characteristic parameters are the ratios between different gases or between different combinations of gases, and the data of the characteristic parameters is preprocessed;

a data transforming module, configured to perform windowing transformation on a data set of the preprocessed characteristic parameters to form a time sequence frame;

a C-LSTM network constructing module, configured to construct the C-LSTM network, which includes an input layer, a convolution layer, an LSTM layer, and an output layer; the input layer reads the time sequence frame and inputs the time sequence frame to the convolution layer to obtain a time sequence characteristic quantity;

a C-LSTM network training module, configured to input the data of the test set into the LSTM layer of the C-LSTM network for training and use the verification set for verification; the network parameters are continuously updated to obtain a trained C-LSTM network prediction model;

a testing module, configured to input the DGA data of the transformer to be monitored into the trained C-LSTM network prediction model for prediction;

an updating module, configured to add the new DGA data of the transformer to be monitored to the test set and the verification set simultaneously to perform repeated calculation and update on the network parameters of the C-LSTM network prediction model again.

The system can realize all other functions in the technical solution of the above method, which will not be repeated here.

It should be understood that those of ordinary skill in the art can make improvements or changes based on the above description, and all these improvements and changes should fall within the protection scope of the appended claims of the present disclosure.

What is claimed is:

1. A transformer DGA data prediction method based on multi-dimensional time sequence frame convolution LSTM, comprising the following steps:
1) collecting and sorting monitoring information of a dissolved gas in transformer substation oil according to a time sequence, wherein the monitoring information comprises a content of key gas in a DGA state of a transformer, and the monitoring information is divided into a test set and a verification set randomly according to a specific proportion;
2) extracting characteristic parameters from the test set and the verification set by adopting a non-coding ratio method, wherein the characteristic parameters are ratios between different gases or between different combinations of gases, and performing preprocessing on data of the characteristic parameters;
3) performing windowing transformation on a data set of the preprocessed characteristic parameters to form a time sequence frame;
4) constructing a C-LSTM network, which comprises an input layer, a convolution layer, an LSTM layer, and an output layer, wherein the input layer reads the time sequence frame and inputs the time sequence frame to the convolution layer to obtain a time sequence characteristic quantity;
5) inputting data of the test set into the LSTM layer of the C-LSTM network for training and using the verification set for verification, wherein network parameters are continuously updated to obtain a trained C-LSTM network prediction model;
6) inputting DGA data of the transformer to be monitored into the trained C-LSTM network prediction model for prediction, and adding new DGA data of the transformer to be monitored to the test set and the verification set simultaneously to perform repeated calculation and update on the network parameters of the C-LSTM network prediction model again.

2. The transformer DGA data prediction method based on multi-dimensional time sequence frame convolution LSTM according to claim 1, wherein the monitoring information of the dissolved gases in the transformer substation oil in step 1) is retrieved from relevant literature, each group of data of the monitoring information is sorted according to the time sequence and at least comprises the content of key gas in DGA state of the transformer: hydrogen Hz, methane CH₄, ethane C₂H₆, ethylene C₂H₄, and acetylene C₂H₂.

3. The transformer DGA data prediction method based on multi-dimensional time sequence frame convolution LSTM according to claim 1, wherein the training set and the verification set are divided through proportional random sampling.

4. The transformer DGA data prediction method based on multi-dimensional time sequence frame convolution LSTM according to claim 1, wherein in step 2), following nine ratios of gas are extracted as the characteristic parameters by using the non-coding ratio method: CH₄/H₂, C₂H₄/(C₁+C₂), C₂H₄/C₂H₂, C₂H₂/(C₁+C₂), CH₄/(C₁+C₂), H₂/(H₂+C₁+C₂), C₂H₄/C₂H₆, (CH₄+C₂H₄)/(C₁+C₂) and C₂H₆/(C₁+C₂), wherein C₁ is a hydrocarbon with one carbon (CH₄) and C₂ is a hydrocarbon with two carbons (C₂H₆, C₂H₄, C₂H₂); a maximum value of the ratios is set, if denominator is zero, then a calculation result of the ratios is set as the maximum value.

5. The transformer DGA data prediction method based on multi-dimensional time sequence frame convolution LSTM according to claim 1, wherein the preprocessing is specifically as follows: a global normalization process is performed on the data; a shorter sequence or a sequence with a non-linear sampling time is expanded by interpolation and superimposed with Gaussian noise.

6. The transformer DGA data prediction method based on multi-dimensional time sequence frame convolution LSTM according to claim 1, wherein the method of performing windowing transformation to form the time sequence frame in step 3) comprising: the result obtained by the non-coding ratio method is formed into a matrix of k rows and n columns, and each of the ratios is arranged as a row according to a sampling time distribution, and k is a number of the characteristic parameters; a matrix filter with x rows and a length being the window size m is used to slide along the sampling time and the characteristic parameters in sequence, a sliding stride is s, and one frame is obtained when each step is moved by one time stride, and a total of (k−x+1)(n−m+1) frames are obtained and arranged along a time axis to form a matrix of x×m×(k−x+1)(n−m+1), that is, the time sequence frame.

7. The transformer DGA data prediction method based on multi-dimensional time sequence frame convolution LSTM according to claim 6, wherein after the time sequence frame in step 4) is subjected to a activation function of a last pooling layer of the convolution layer in the C-LSTM network prediction model, the matrix of x×m×(k−x+1)(n−m+1) is changed into a characteristic vector sequence of D×(k−x+1)(n−m+1), wherein D is a number of characteristic parameters.

8. The transformer DGA data prediction method based on multi-dimensional time sequence frame convolution LSTM according to claim 1, wherein a training method of the C-LSTM network prediction model in step 5) is as follows: first, a number of training cycles, a minimum training batch, a activation function, and a learning rate are set; the time sequence frame obtained by the training set after step 2) to step 3) serves as network input; then a calculation method of network error is set; if a learning ability expressed by high-level time needs to be enhanced, multiple LSTM layers are set; finally the network training is performed to obtain the C-LSTM prediction network model; in a training process of the training method, each time when next time sequence value is obtained, it is considered that a true value at a previous moment is known, and the network parameters are continuously updated through an effect of the verification set test, and finally the trained C-LSTM network prediction model is obtained.

9. The transformer DGA data prediction method based on multi-dimensional time sequence frame convolution LSTM according to claim 1, wherein a method of repeated calculation and update of the C-LSTM network prediction model at a later stage in step 6) is as follows: first, an update frequency of the C-LSTM network prediction model is set at a frequency of updating by every q times of monitoring sampling, when q new monitoring data is obtained, previous monitoring information of the transformer to be predicted is added to the training set and the verification set simultaneously, and return to step 2) to repeatedly calculate and update the network parameters.

10. A transformer DGA data prediction system based on multi-dimensional time sequence frame convolution LSTM, comprising:
an information collecting module, configured to collect and sort monitoring information of a dissolved gas in transformer substation oil according to a time sequence, wherein the monitoring information comprises a content of key gas in DGA state of a transformer, and the monitoring information is divided into a test set and a verification set randomly according to a specific proportion;
a characteristic parameter extracting module, configured to extract characteristic parameters from the test set and the verification set by adopting a non-coding ratio method, wherein the characteristic parameters are ratios between different gases or between different combinations of gases, and configured to perform preprocessing on data of the characteristic parameters;
a data transforming module, configured to perform windowing transformation on a data set of the preprocessed characteristic parameters to form a time sequence frame;
a C-LSTM network constructing module, configured to construct a C-LSTM network, which comprises an input layer, a convolution layer, an LSTM layer, and an output layer, wherein the input layer reads the time sequence frame and inputs the time sequence frame to the convolution layer to obtain a time sequence characteristic quantity;
a C-LSTM network training module, configured to input data of the test set into the LSTM layer of the C-LSTM network for training and use the verification set for verification, wherein network parameters are continuously updated to obtain a trained C-LSTM network prediction model;
a testing module, configured to input DGA data of the transformer to be monitored into the trained C-LSTM network prediction model for prediction;
an updating module, configured to add new DGA data of the transformer to be monitored to the test set and the verification set simultaneously to perform repeated calculation and update on network parameters of the C-LSTM network prediction model again.
